(19) United States
(12) Patent Application Publication
(10) Pub. No.: US 2011/0223800 A1
(43) Pub. Date: Sep. 15, 2011

(54) USB Connector

(76) Inventors: Gang Lee, Shanghai (CN); Chih Hsieh Chang, Taipei (TW); Huibin Li, Shanghai (CN)

(21) Appl. No.: 13/044,894

(22) Filed: Mar. 10, 2011

(30) Foreign Application Priority Data
Mar. 10, 2010 (CN) 201020139418.8

(51) Int. Cl. H01R 3/00

(52) U.S. Cl. 439/488

(57) ABSTRACT

The invention discloses a USB electrical connector including a body, at least one USB function unit held in the body, and a shield for enclosing the body. Each of the USB function unit having a first row of contacts corresponding to a first signal transmission loop, a second row of contacts corresponding to a second signal transmission loop, a first LED corresponding to the first signal transmission loop, for indicating the operation state of the first signal transmission loop, and a second LED corresponding to the second signal transmission loop, for indicating the operation state of the second signal transmission loop. The first and second LEDs each has two pins for being connected with and powered by a motherboard. Each signal transmission loop of the USB function unit has a respective LED for indicating the operation state thereof, thus, the operation state of each signal transmission loop can be directly observed.

### CROSS-REFERENCE TO RELATED APPLICATIONS

This application claims priority under 35 U.S.C. §119 to Chinese Patent Application No. 201020139418.8 filed on Mar. 12, 2010.

### FIELD OF THE INVENTION

The invention relates to a connector, and in particular, relates to a USB connector with an indicator to indicate an operation state of an individual signal transmission loop of a USB connector.

### BACKGROUND

The USB (Universal Serial Bus) is a low cost serial bus that was developed around the idea that users should be able to run multiple peripherals on their computers without the hassle of physically installing boards, manually allocating system resources, individually configuring devices, and powering the computer up and down every time equipment needs change.

The conventional USB (Universal Serial Bus) connector uses two individual signal transmission loops, with automatic error correction and multiple data channels with configurable buffers. However, the conventional USB connector does not provide any indicator to indicate the operation state of each of the two individual signal transmission loops, thus making it difficult for a user to identify the operation state of the two individual signal transmission loops. Particularly, when testing, maintaining or repairing the USB connector, the user must rely on special tools to detect the operation state of the two individual signal transmission loops. Clearly, there has been an increasing demand on improving the operability of the USB connector, such as, providing an indicator to monitor the operation state of each of the two individual signal transmission loops.

### SUMMARY

It is therefore an object of the invention, among other objects, to provide an improved USB connector having an indicator to monitor the operation state of each of the two individual signal transmission loops.

A USB connector includes a body, at least one USB function unit being held in the body, and a shield enclosing the body. Each of the USB function units has a first row of contacts corresponding to a first signal transmission loop, a second row of contacts corresponding to a second signal transmission loop, a first LED corresponding to the first signal transmission loop, for indicating the operation state of the first signal transmission loop, and a second LED corresponding to the second signal transmission loop, for indicating the operation state of the second signal transmission loop. The first and second LEDs each has two pins for being connected with and powered by a motherboard.

### BRIEF DESCRIPTION OF THE DRAWINGS

The present invention is illustrated in greater detail below by exemplary embodiments with reference to the attached drawings, in which:

FIG. 1 is a perspective view of a USB connector showing USB function units from a rear side of the USB connector according to the invention.

FIG. 2 is a perspective view of a USB connector showing pins from a bottom side of the USB connector according to the invention.

### DETAILED DESCRIPTION OF THE EMBODIMENT(S)

The invention is explained in greater detail below with reference to the drawings, wherein like reference numerals refer to the like elements. The invention may, however, be embodied in many different forms and should not be construed as being limited to the embodiments set forth herein; rather, these embodiments are provided so that the description will be thorough and complete, and will fully convey the concept of the invention to those skilled in the art.

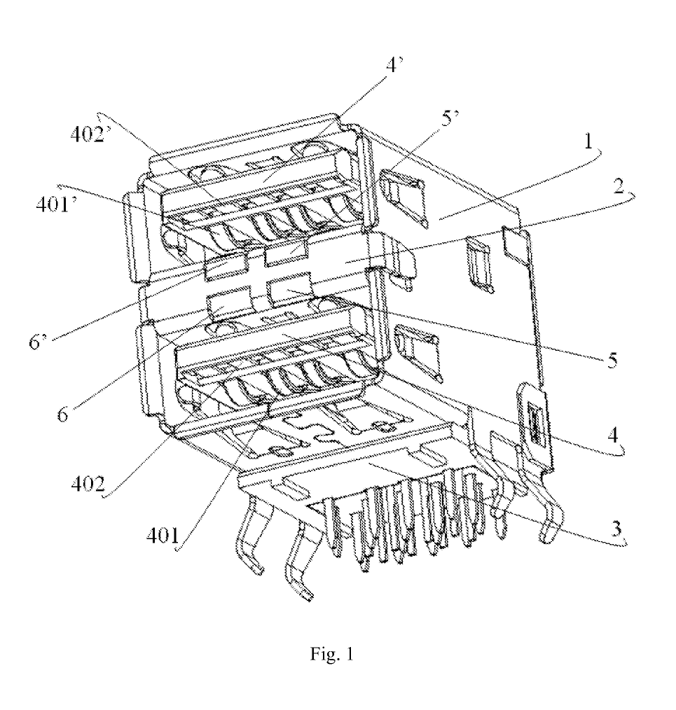

A USB connector according to the invention, illustrated in perspective view in FIG. 1 includes a body 3 formed of insulative material, two USB function units 4, 4′, and a shield 1 formed of metal. In the embodiment shown in FIG. 1, the first USB function unit 4 includes a first row of contacts 401 corresponding to a first signal transmission loop, and a second row of contacts 402 corresponding to a second signal transmission loop. The first USB function unit 4 further includes a first LED (light-emitting diode) 5 corresponding to the first signal transmission loop, for indicating the operation state of the first signal transmission loop, and a second LED 6 corresponding to the second signal transmission loop, for indicating the operation state of the second signal transmission loop. Here, the invention is not limited to the embodiment shown in FIG. 1, and the USB connector may include one USB function unit, three or more USB function units, and each USB unit may uses more than two or multiple signal transmission loops or modes, depending on the design and usage of the USB connector.

In the embodiment shown in FIG. 1, the first LED 5 or the second LED 6 corresponding to the first or the second signal transmission loop of the first USB function unit 4 is turned on when the first or the second signal transmission loop of the first USB function unit 4 is in a normal operation state, and the first LED 5 or the second LED 6 corresponding to the first or the second signal transmission loop of the first USB function unit 4 is turned out when the first or the second signal transmission loop of the first USB function unit 4 is in an out-of operation state. Therefore, by viewing whether the first or the second LED 5 or 6 is turned on or off, the user is able to directly monitor the operation state of each signal transmission loop of the first USB function unit 4, which is considerably more convenient for the user to test, maintain and/or repair the USB connector.

Similarly, as shown in FIG. 1, the second USB function unit 4′ includes a first row of contacts 401′ corresponding to a first signal transmission loop, and a second row of contacts 402′ corresponding to a second signal transmission loop. The second USB function unit 4′ further includes a first LED 5′ corresponding to the first signal transmission loop, for indicating the operation state of the first signal transmission loop, and a second LED 6′ corresponding to the second signal transmission loop, for indicating the operation state of the second signal transmission loop.

In the embodiment shown in FIG. 1, the first LED 5′ or the second LED 6′ corresponding to the first or the second signal transmission loop of the second USB function unit 4′ is turned on when the first or the second signal transmission loop is in a normal operation state, and the first LED 5′ or the second LED 6′ corresponding to the first or the second signal transmission loop of the second USB function unit 4′ is turned out when the first or the second signal transmission loop is in an out-of operation state. Therefore, by viewing whether the first or the second LED 5′ or 6′ is turned on or off, the user is able to directly monitor the operation state of each signal transmission loop of the second USB function unit 4′, which is considerably more convenient for the user to test, maintenance and/or repair the USB connector.

In order to identify the first LED 5 corresponding to the first signal transmission loop from the second LED 6 corresponding to the second signal transmission loop in the first USB function unit 4, in another embodiment of the invention, the first LED 5 and the second LED 6 are set to have different colors from each other, for example, the first LED 5 may be red, and the second LED 6 may be green. In this way, the user can easily distinguish the first LED 5 and the second LED 6 of the first USB function unit 4.

Similarly, in order to identify the first LED 5′ corresponding to the first signal transmission loop from the second LED 6′ corresponding to the second signal transmission loop in the second USB function unit 4′, in another embodiment of the invention, the first LED 5′ and the second LED 6′ are set to have different colors from each other, for example, the first LED 5′ may be blue, and the second LED 6′ may be yellow. In this way, the user can easily distinguish the first LED 5′ and the second LED 6′ of the second USB function unit 4′.

As shown FIG. 1, the USB connector further includes a finger member 2 being secured on the shield 1 at both ends thereof. The finger member 2 is located between the first USB function unit 4 and the second USB function unit 4′ to separate the first USB function unit 4 from the second USB function unit 4′.

In the embodiment of FIG. 1, the first and second LEDs 5, 6 of the first USB function unit 4 are arranged in one side of the finger member 2, and the first and second LEDs 5′, 6′ of the second USB function unit 4′ are arranged in the other side of the finger member 2. In this way, the user is able to straightforwardly identify the first and second LEDs 5, 6 of the first USB function unit 4 from the first and second LEDs 5′, 6′ of the second USB function unit 4′.

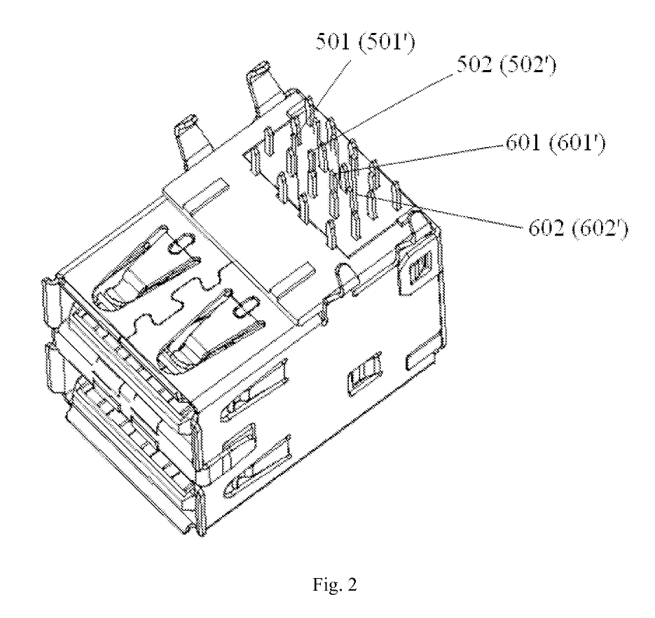

FIG. 2 shows the pins on the bottom of the USB connector. As shown in FIG. 2, the first LED 5 of the first USB function unit 4 has two pins 501, 502 connected with and powered by a motherboard (not shown), and the second LED 6 of the first USB function unit 4 has two pins 601, 602 connected with and powered by the motherboard. Similarly, the first LED 5′ of the second USB function unit 4′ has two pins 501′, 502′ connected with and powered by the motherboard, and the second LED 6′ of the second USB function unit 4′ has two pins 601′, 602′connected with and powered by the motherboard.

In the embodiment of the invention shown in FIG. 2, two pins 501, 502 of the LED 5 of the first USB function unit 4 and two pins 501′, 502′ of the LED 5′ of the second USB function unit 4′ may share the same pins, respectively, and two pins 601, 602 of the LED 6 of the first USB function unit 4 and two pins 601′, 602′ of the LED 6′ of the second USB function unit 4′ may also share the same pins, respectively. In this way, the total number of the pins for LEDs 5, 6, 5′, 6′ may be reduced. In another embodiment of the invention, two pins 501, 502 of the LED 5 of the first USB function unit 4 and two pins 501′, 502′ of the LED 5′ of the second USB function unit 4′ may not share the same pins, respectively, and two pins 601, 602 of the LED 6 of the first USB function unit 4 and two pins 601′, 602′ of the LED 6′ of the second USB function unit 4′ may also not share the same pins, respectively.

Although several embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. An electrical connector, comprising:
a body;
at least one function unit held in the body having:
a first row of contacts corresponding to a first signal transmission loop;
a second row of contacts corresponding to a second signal transmission loop;
a first LED corresponding to the first signal transmission loop, for indicating the operation state of the first signal transmission loop; and
a second LED corresponding to the second signal transmission loop, for indicating the operation state of the second signal transmission loop,
wherein the first and second LEDs each has two pins configured to be connected with and powered by a motherboard; and
a shield for enclosing the body.

2. The electrical connector according to claim 1, wherein the first and second LEDs of each of the function units have different working colors.

3. The electrical connector according to claim 1, wherein the electrical connector comprises two function units separate from each other.

4. The electrical connector according to claim 3, further comprising a finger member, on which the LEDs of the two separate function units are all arranged and secured on the shield.

5. The electrical connector according to claim 4, wherein the finger member is located between the two separate function units.

6. The electrical connector according to claim 3, wherein the first and second LEDs of each of the function units have different working colors.

7. The electrical connector according to claim 4, wherein the first and second LEDs of each of the function units have different working colors.

8. The electrical connector according to claim 5, wherein the first and second LEDs of each of the function units have different working colors.

9. The electrical connector according to claim 1, wherein the two pins of the first and second LEDs of each of the function units may share the same pins, respectively.
